(19) United States
(12) Patent Application Publication
(10) Pub. No.: US 2004/0057563 A1
(43) Pub. Date: Mar. 25, 2004

(54) TCP/IP network system constructing by power lines

(75) Inventors: Chih-Sheng Chang, Taipei (TW); Chih-Chien Hu, Taipei (TW)

Correspondence Address: BACON & THOMAS, PLLC, 625 SLATERS LANE, FOURTH FLOOR, ALEXANDRIA, VA, 22314

(73) Assignee: Institute For Information Industry, Taipei (TW)

(21) Appl. No.: 10/251,970

(22) Filed: Sep. 23, 2002

(51) Int. Cl. H04M 11/00

(52) U.S. Cl. 379/90.01

(57) ABSTRACT

A TCP/IP network system constructing by power lines has a plurality of embedded data processors, a plurality of modems, at least a computer device or speech device, power lines which are used to construct a local network. The embedded data processor is internally connected to a computer device or a speech device and externally connected to an external broadband network. The modem is connected to other computer devices and speech devices in the local modem, or the external broadband network for data transfer.

### BACKGROUND OF THE INVENTION

1. Field of the Invention

The present invention relates to local network system, and particularly to a TCP/IP network system constructing by power lines.

2. Background of the Invention

With the advance of computer industry, the computer and other related devices are widely and massively used at homes or offices. Thus, there are many signal lines (such as network lines or telephone lines) distributed indoors so that the larger space is necessary to accommodate the lines.

In general, power lines are widely used in home and offices. Thereby, the power lines and network lines are massively used indoors. Thereby, there is a demand for combining the use of the power lines and network lines so as to save the space occupied.

### SUMMARY OF THE INVENTION

Accordingly, the primary object of the present invention is to provide a TCP/IP network system constructing by power lines, wherein power lines are used to replace network lines and telephone lines to construct a local network.

Another object of the present invention is to provide a TCP/IP network system constructing by power lines, wherein the local network is formed without changing the indoor line structure.

To achieve above objects, the present invention provide a TCP/IP network system constructing by power lines, which comprises: a plurality of embedded data processors, wherein one of which is used as a central processing node connected to an external broadband network for processing network packages from the external broadband network, and the other embedded data processors are used as network nodes, each connected to a computer device or a speech device for processing data packages from the computer device or speech package from the speech device; and a plurality of modems, each connected to one embedded data processor and a power line, wherein the embedded data processor is connected through power lines so as to form an local network, and the packages from the embedded data processor is modulated and demodulated for being transferred through the power lines.

The various objects and advantages of the present invention will be more readily understood from the following detailed description when read in conjunction with the appended drawing.

### BRIEF DESCRIPTION OF THE DRAWINGS

FIG. 1 shows a systematic structure of the present invention.

FIG. 2 is a function block diagram of the network nodes of the embedded data processor of the present invention.

FIG. 3 shows the function block diagram of the central control node of the embedded data processor of the present invention.

### DETAILED DESCRIPTION OF THE PREFERRED EMBODIMENTS

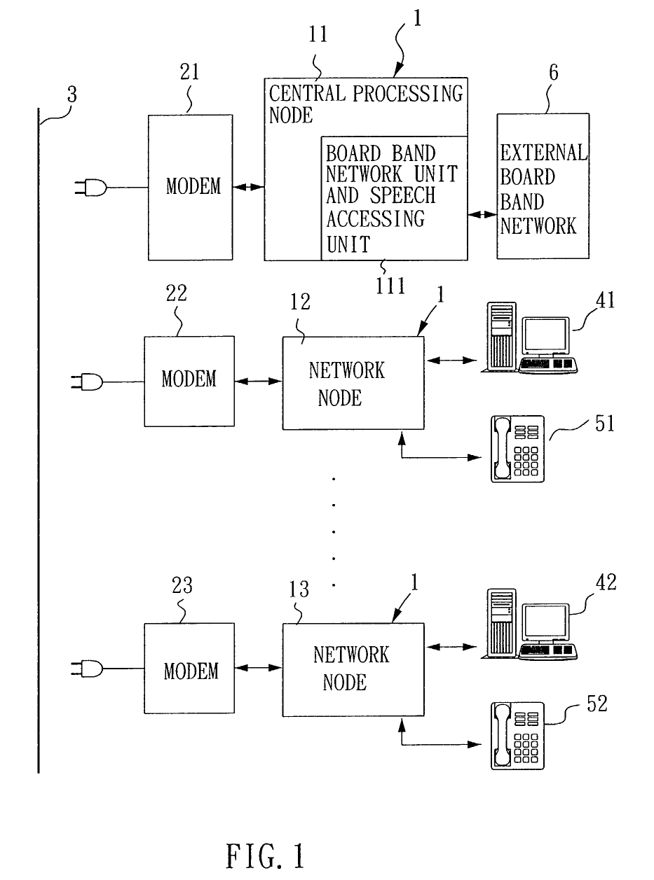

One preferred embodiment of the TCP/IP network system constructing by power lines in accordance with the present invention will be described hereinafter, in which an Ethernet constructed from power lines is used as an example. Referring to FIG. 1, the TCP/IP network system constructing by power lines of the present invention is formed by a plurality of embedded data processor 1, and a plurality of modems 21, 22 and 23, power lines 3, computer devices 41, 42 and speech devices 51 and 52. The embedded data processor 1 has two types, one is a central processing node 11 and the other is a network node 12 and 13.

The central processing node 11 is externally connected to an external broadband network 6 and internally connected other Ethernet device through the modem 21 by a power line 3 so that the center control node 21 is used as a communication device between the external broadband network 6 and Ethernet. The external broadband network 6 may be one of public switching telephone network (PSTN), integrated service digital network (ISDN), broadband cable network, digital service loop (xDSL), or optical fiber communication network.

Other network nodes 12 and 13 serve to connect the computer devices 41, 42 or the speech devices 51, 52. The computer devices 41, 42 or the speech devices 51, 52 can be connected to the computer devices or speech devices in Ethernet through the network nodes 12 and 13 and the modems 22 and 23 or connected to the external broadband network 6 or the speech device through the center control node 21. In this embodiment, the speech devices 51 and 52 are preferably IP phones.

The modems 21, 22 and 23 have plugs for being inserted into the receptacle so as to be connected to the power line 3. The central processing node 21 has a broadband network unit and speech processing unit 111 for processing the network packages (data or speech package, or package containing data and speech) through the external broadband network 6 for processing signals demodulated from the modem 21 by using network protocol.

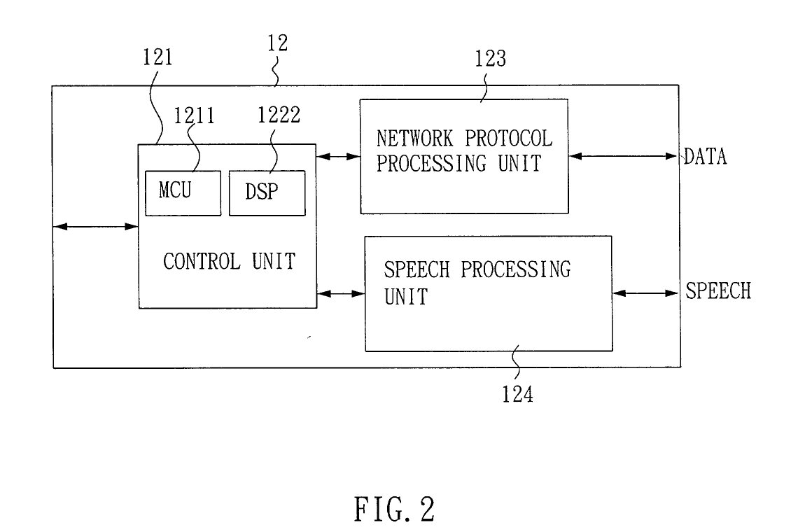

Referring to FIG. 2, the structure of the network node 12 is illustrated. The network node 12 has a network protocol processing unit 123, a speech processing unit 124, and a control unit 121. The control unit 121 further includes a digital signal processor 1222 and a microprocessor 1211. The microprocessor 1211 serves for controlling the network protocol processing unit 123 and the speech processing unit 124 so that the network protocol processing unit 123 processes the signals from the computer device 41 by using Ethernet protocol and encodes the speech from the speech device 52 by using speech processing unit 124. The processed data packages and speech packages are sent to the control unit 121 for being converted to Ethernet packages. The processed speech packages are sent to the control unit 121. The digital signal processor 1222 serves to process the signals to have a preset format.

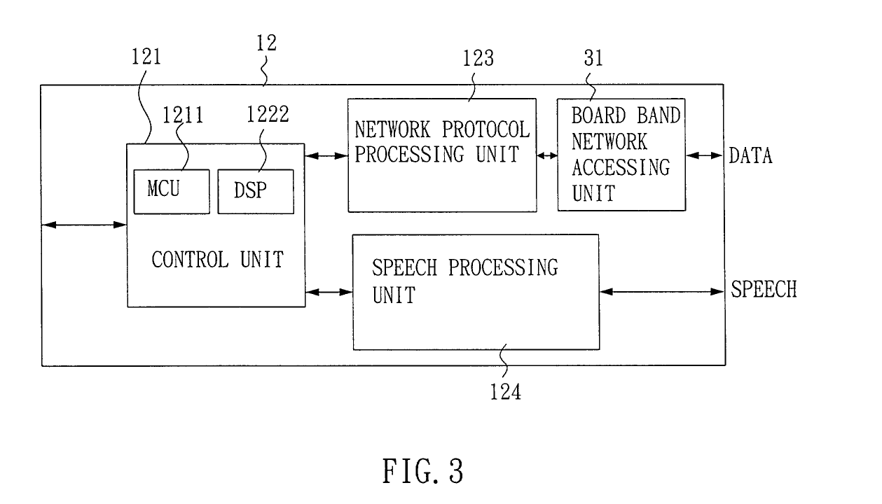

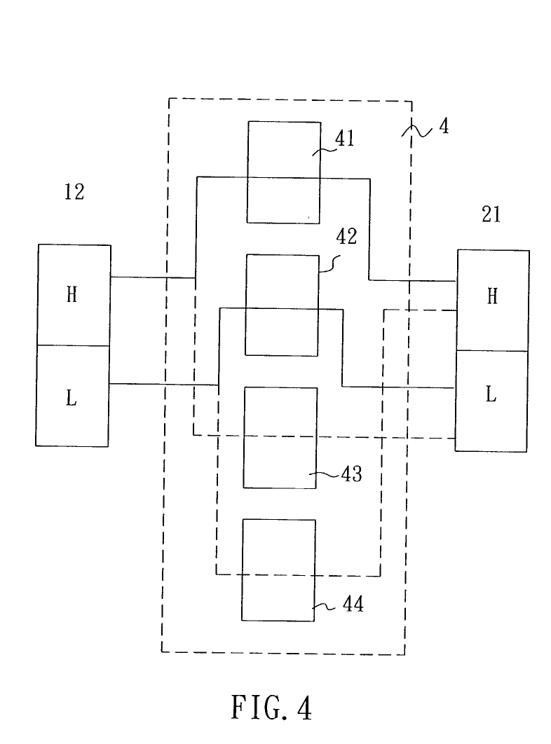

Then, the Ethernet packages are sent to the modem 22 for demodulation. Thereby, the packages are sent to other device of the Ethernet through the power line 3 or sent to the central processing node 11 through the power line 3, and then is sent to the external broadband network 6. FIG. 3 shows the structure of the central processing node 11, which has a structure similar as the network node 12. The central processing node 11 further has a broadband network accessing unit 31 which is connected to the external broadband network 6 for processing the network packages transferred to the external broadband network 6.

Besides, the network node 12 can process the Ethernet packages from the power line 3. The Ethernet network package is sent to the modem 22 through the power line 3 for demodulating, and then is sent to the network node 12 for classifying the packages into speech packages or data packages. Next, the speech packages are processed through the digital signal processor 1222 and the speech processing unit 124 to be transformed into speech signals. Then, the signal is sent to the speech device 51. The data package is sent to the network protocol processing unit 123 for processing and then is sent to the computer device 41.

The present invention is thus described. It will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A TCP/IP network system constructing by power lines comprising:
a plurality of embedded data processors, wherein one of which is used as a central processing node connected to an external broadband network for processing network packages from the external broadband network, and the other embedded data processors are used as network nodes, each connected to a computer device or a speech device for processing data packages from the computer device or speech package from the speech device; and
a plurality of modems, each connected to one embedded data processor and a power line, wherein the embedded data processor is connected through power lines so as to form an local network, and the packages from the embedded data processor is modulated and demodulated for being transferred through the power lines.

2. The TCP/IP network system constructing by power lines as claimed in claim 1, wherein the network node comprises:
a network protocol processing unit for processing data packages based on the local network protocol;
a speech processing unit for encoding speech signals; and
a control unit for controlling the network protocol processing unit and the speech processing unit so that the processed packages having preset format are sent to the power lines, or packages from the power lines are sent to the network protocol processing unit or the speech processing unit for being further processed.

3. The TCP/IP network system constructing by power lines as claimed in claim 2, wherein the control unit further has a digital signal processor (DSP) for processing the packages that the speech processing unit processed.

4. The TCP/IP network system constructing by power lines as claimed in claim 1, wherein the external broadband network is selected from one of public switching telephone network (PSTN), integrated service digital network (ISDN), broadband cable network, digital service loop (xDSL), or optical fiber communication network.
